(19) United States
(12) Patent Application Publication
(10) Pub. No.: US 2022/0407044 A1
(43) Pub. Date: Dec. 22, 2022

(54) Dry Manufacturing Method of Positive Electrode for Lithium Secondary Battery, the Positive Electrode Manufactured Thereby, and the Lithium Secondary Battery Comprising the Positive Electrode

(71) Applicant: LG Energy Solution, Ltd., Seoul (KR)

(72) Inventors: Nam Jeong Lee, Daejeon (KR); Sang Min Kwak, Daejeon (KR); Ki Seok Lee, Daejeon (KR); Koo Seung Chung, Daejeon (KR); Dong Oh Shin, Daejeon (KR); Kwang Ho Yoo, Daejeon (KR)

(73) Assignee: LG Energy Solution, Ltd., Seoul (KR)

(21) Appl. No.: 17/836,660

(22) Filed: Jun. 9, 2022

(30) Foreign Application Priority Data
Jun. 16, 2021 (KR) 10-2021-0078198

(51) Int. Cl. H01M 4/04; H01M 4/62; H01M 4/505; H01M 4/58

(52) U.S. Cl. CPC H01M 4/0435; H01M 4/623; H01M 4/625; H01M 4/505; H01M 4/5825; H01M 2004/028

(57) ABSTRACT

The present technology relates to a dry method of manufacturing a positive electrode for a lithium secondary battery, a positive electrode manufactured thereby, and a lithium secondary battery including the same. Thereby, a positive electrode including a positive electrode mixture layer with an appropriate density, and effective adhesion between the positive electrode mixture layer and the current collector may be realized.

### CROSS-REFERENCE TO RELATED APPLICATION

This application claims the benefit of Korean Patent Application No. 10-2021-0078198, filed on Jun. 16, 2021, the disclosure of which is incorporated herein by reference in its entirety.

### TECHNICAL FIELD

The present disclosure relates to a dry method of manufacturing a positive electrode for a lithium secondary battery, a positive electrode manufactured thereby, and a lithium secondary battery.

### BACKGROUND TECHNOLOGY OF THE INVENTION

Recently, demand for secondary batteries as an energy source is rapidly increasing. Among these secondary batteries, lithium secondary batteries with high energy density and voltage, a long cycle life and a low self-discharging rate have been commercialized and widely used.

Generally, a secondary battery consists of a positive electrode, a negative electrode, an electrolyte, and a separator. Among them, the positive electrode may include a positive electrode active material, a conductive material, and a binder.

In a conventional process of manufacturing a positive electrode, a positive electrode is manufactured by preparing a positive electrode slurry by dispersing or dissolving a positive electrode active material, a conductive material and a binder using a solvent, coating the positive electrode slurry on a current collector, drying the coated slurry, and rolling the resultant with high pressure. Therefore, when considering a suitable viscosity for the process of manufacturing a positive electrode, there is a problem in that there are upper limits on the contents of the binder and conductive material, which can be input into the solvent, and on the content of solid content of the prepared positive electrode slurry.

In addition, when the positive electrode is manufactured using the positive electrode slurry using a solvent, as the solvent contained in an electrode mixture evaporates during the drying process, defects such as pinholes or cracks may be induced. In addition, since the inside/outside of the slurry coating layer is not dried uniformly, a powder floating phenomenon caused by the difference in solvent evaporation rate, that is, the powder in a region that is first dried rises, so it may have a gap with an area that is dried relatively later and the quality of the electrode may be degraded. Therefore, although a drying device capable of uniformly drying the inside/outside of an active layer and adjusting an evaporation rate of a solvent is considered, such drying devices are disadvantageous in terms of manufacturing processability due to being expensive and requiring considerable costs and time for operation.

In order to solve the above problems, a method of manufacturing an electrode without using a positive electrode slurry has been suggested. Specifically, in the manufacturing method, a mixture film may be formed by mixing a positive electrode active material, a binder and a conductive material without a liquid medium such as a solvent or a dispersion medium and passing the powder mixture through a calender roll. In addition, a positive electrode may be manufactured to have a structure in which a positive electrode mixture layer is formed on a current collector by laminating the mixture film thereon.

Meanwhile, in the lamination process, a rolling process that applies pressure is performed simultaneously or separately to increase the density of a positive electrode mixture layer and adhere the positive electrode mixture layer to a current collector. However, in the rolling process, when a gap between the first and second press rolls is less than a predetermined range, the density of the positive electrode mixture layer increases more than necessary, showing a lower porosity than a target porosity, or damaging the active material or the current collector. In addition, when the gap between the first and second press rolls exceeds the predetermined range, there is a problem in which the adhesion between the positive electrode mixture layer and the current collector is lowered.

Therefore, when the positive electrode is manufactured by the dry electrode manufacturing method without using a solvent, it is necessary to develop a method of manufacturing a positive electrode for a lithium secondary battery that can include a positive electrode mixture layer having a suitable density and realize effective adhesion between the positive electrode mixture layer and the current collector.

### DESCRIPTION OF THE INVENTION

### Technical Problem

Therefore, the present technology is directed to providing a dry method of manufacturing a positive electrode for a lithium secondary battery that can include a positive electrode mixture layer having a suitable density and porosity, and realize effective adhesion between the positive electrode mixture layer and a current collector, a positive electrode manufactured thereby, and a lithium secondary battery including the same.

### Technical Solution

To solve the above-described problem, one embodiment of the present invention provides a dry method of manufacturing a positive electrode for a lithium secondary battery, which includes:

laminating a mixture film including a positive electrode active material, a conductive material and a binder on one or both surfaces of a current collector, wherein, during the lamination, the mixture film satisfies a compression ratio (%) of Equation 1:

30≤Tₚ/T₁×100≤50 [Equation 1]

In Equation 1,

Tₚ indicates a pressing thickness in the lamination, and

T₁ indicates the thickness of the mixture film before the lamination.

Here, in the lamination, the density increase rate (%) of the mixture film may satisfy Equation 2 below:

8≤(D₂−D₁)/D₁×100≤15 [Equation 2]

D₁ indicates the density of the mixture film before the lamination, and

D₂ indicates the density of the mixture film after the lamination.

In addition, in the lamination, the rolling rate of the mixture film may be 20% or less.

Moreover, before the lamination, the dry method of the present technology may further include forming a primer layer including a conductive material and a binder on one or both surfaces of the current collector.

Furthermore, the dry method of manufacturing a positive electrode for a lithium secondary battery according to the present technology may further include obtaining a powder mixture by dry mixing a positive electrode active material, a conductive material and a binder; and forming a mixture film by calendering the powder mixture.

In a specific example, the obtaining of a powder mixture may include obtaining a mixture by mixing a positive electrode active material, a conductive material and a binder; forming a bulk mixture in the form of a lump by fiberizing the binder by applying shear stress to the mixture; and obtaining a powder mixture by pulverizing the bulk mixture.

In addition, the lamination may be performed by a press roll, and the temperature of the press roll may range from 40 to 200° C. on average.

In addition, one embodiment of the present invention provides a positive electrode for a lithium secondary battery, which includes:

a current collector;

a primer layer formed on one or both surfaces of the current collector; and

a positive electrode mixture layer disposed on an upper surface of the primer layer and including a positive electrode active material, a conductive material and a binder,

wherein the positive electrode mixture layer has a structure formed by the fiberization of the binder and has a density of 2 to 4 g/cm³.

Meanwhile, the positive electrode mixture layer may include 85 to 98 parts by weight of the positive electrode active material; 0.5 to 5 parts by weight of the conductive material; and 0.5 to 10 parts by weight of the binder. In addition, as the binder of the positive electrode mixture layer, polytetrafluoroethylene (PTFE) may be included.

In addition, the primer layer may include a conductive material and a binder, and here, the conductive material and the binder may be included at a weight ratio of 1:10 to 9:10.

In addition, the binder included in the primer layer may be one or more selected from the group consisting of acrylonitrile-butadiene rubber, acrylonitrile-butadiene-styrene rubber, polyvinylidene fluoride, a polyvinylidene fluoride-based copolymer, and an acryl-based resin.

Furthermore, one embodiment of the present invention provides a lithium secondary battery, which includes:

a positive electrode; a negative electrode; and a separator disposed between the positive electrode and the negative electrode.

### Advantageous Effects

According to a dry method of manufacturing a positive electrode for a lithium secondary battery, a positive electrode manufactured thereby, and a lithium secondary battery including the same according to the present technology, effective adhesion between a positive electrode mixture layer and a current collector can be realized.

### BRIEF DESCRIPTION OF THE DRAWINGS

FIG. 1 is a schematic diagram illustrating conditions for a lamination process in a dry method of manufacturing a positive electrode for a lithium secondary battery according to one embodiment of the present invention.

### BEST MODE FOR CARRYING OUT THE INVENTION

The present invention may have various modifications and various examples, and thus specific examples are illustrated in the drawings and described in detail in the detailed description.

However, it should be understood that the present invention is not limited to specific embodiments, and includes all modifications, equivalents or alternatives within the spirit and technical scope of the present invention.

The terms “comprise,” “include” and “have” used herein designate the presence of characteristics, numbers, steps, actions, components or members described in the specification or a combination thereof, and it should be understood that the possibility of the presence or addition of one or more other characteristics, numbers, steps, actions, components, members or a combination thereof is not excluded in advance.

In addition, when a part of a layer, film, region or plate is disposed “on” another part, this includes not only a case in which one part is disposed “directly on” another part, but also a case in which still another part is interposed therebetween.

In contrast, when a part of a layer, film, region or plate is disposed “under” another part, this includes not only a case in which one part is disposed “directly under” another part, but also a case in which still another part is interposed therebetween. In addition, in this application, “on” may include not only a case of disposed on an upper part but also a case of disposed on a lower part.

Hereinafter, the present invention will be described in further detail.

Dry Method of Manufacturing Positive Electrode for Lithium Secondary Battery

In one embodiment of the present invention, a dry method of manufacturing a positive electrode for a lithium secondary battery includes laminating a mixture film including a positive electrode active material, a conductive material and a binder on one or both surfaces of a mixture film, wherein, during the lamination, the mixture film satisfies a compression ratio (%) of Equation 1:

30≤Tₚ/T₁×100≤50 [Equation 1]

In Equation 1,

Tₚ indicates a pressing thickness of the mixture film in the lamination, and

T₁ indicates the thickness of the mixture film before the lamination.

In the dry method of manufacturing a positive electrode for a lithium secondary battery according to the present technology, a positive electrode may be manufactured through a lamination process of integrating a mixture film and a current collector while taking out the wound mixture film and the wound current collector. The lamination may be to simultaneously perform stacking and rolling of the mixture film on one or both surfaces of the current collector, and performed using a press roll. However, the lamination may include obtaining a laminate by stacking the mixture film including a positive electrode active material, a conductive material and a binder on one or both surfaces of the current collector as necessary, and rolling the laminate such that a compression ratio of the mixture film stacked on the current collector satisfies Equation 1, but the present invention is not limited thereto.

In a specific example, the dry method of manufacturing a positive electrode for a lithium secondary battery according to the present technology may be performed by preparing a mixture film including a positive electrode active material, a conductive material and a binder, and performing lamination to integrate the mixture film with the current collector such that the compression ratio of the mixture film satisfies Equation 1. Meanwhile, the pressing thickness (Tₚ) of the mixture film refers to a thickness of the mixture film to be pressed when pressed by a press roll to be described below.

Here, the mixture film may be formed by calendering a mixed powder obtained by dry mixing a positive electrode active material, a conductive material and a binder. Specifically, the mixture film may be obtained by obtaining a powder mixture by dry mixing a positive electrode active material, a conductive material and a binder; and calendering the powder mixture.

In one example, the obtaining of the powder mixture may include obtaining a mixture by mixing a positive electrode active material, a conductive material and a binder; forming a bulk mixture in the form of a lump by fiberizing the binder by applying shear stress to the mixture; and obtaining a powder mixture by pulverizing and sorting the bulk mixture. Meanwhile, in the forming of the bulk mixture, the mixture may be kneaded in a temperature range of 70 to 200° C. at atmospheric pressure or less, and in the obtaining of the powder mixture, the bulk mixture may be pulverized and sorted to have a particle diameter of 2 mm or less, or 1 mm or less. For example, in the obtaining of the powder mixture, each component may be put into a blender and stirred for 30 seconds to 10 minutes at 5,000 to 15,000 rpm, the resulting mixture is put into a kneader at 70 to 200° C. to mix at 20 to 100 rpm for 1 to 10 minutes, thereby obtaining a bulk mixture. The bulk mixture may be put into a blender and pulverized for 10 seconds to 5 minutes at 5,000 to 15,000 rpm, thereby obtaining a powder mixture. In addition, the powder mixture may be put into a calender at 80 to 150° C., thereby forming a mixture film.

In another example, before the lamination, forming a primer layer including a conductive material and a binder on one or both surfaces of the current collector may be included.

Specifically, in the forming of a primer layer including a conductive material and a binder on one or both surfaces of the current collector, a primer layer may be formed by preparing a slurry for forming a primer layer including a conductive material, a binder and a solvent, applying the slurry for forming a primer layer to one or both surfaces of the current collector, and drying the applied slurry. The solvent may be water, methanol, ethanol, ethylene glycol, diethylene glycol, glycerol, methyl pyrrolidone, or a mixture thereof. Here, as a primer coating layer is further included on the current collector, in the lamination to be described below, the adhesion between the current collector and the mixture film may be improved.

In addition, the lamination may be to laminate the mixture film on one or both surfaces of the current collector using a press roll. Moreover, during the lamination, the mixture film and the current collector may be laminated such that the compression ratio of the mixture film satisfies Equation 1. Specifically, the compression ratio of the mixture film may satisfy 30% to 50%, 35% to 50%, or 40 to 50%. Here, the compression ratio refers to a rate (Tₚ/T₁) of the pressing thickness (Tₚ) of the mixture film during lamination to the thickness (T₁) of the mixture film before lamination. In the lamination, as the compression ratio is adjusted to satisfy a specific range, an appropriate density and porosity of the mixture film and excellent adhesion between the mixture film and the current collector may be provided.

When the compression ratio of the mixture film in Equation 1 is less than 30%, since the adhesion between the mixture film and the current collector is lowered due to a low pressure applied to the mixture film, there may be a problem in that the mixture film is delaminated from the current collector after the lamination process. Moreover, when the compression ratio of the mixture film is more than 50%, since the density of the mixture film increases more than necessary, there is a problem in that a porosity is lower than the target porosity or the current collector is damaged.

In addition, during the lamination, when the compression ratio of the mixture film integrated with the current collector satisfies Equation 1, the density increase rate (%) of the mixture film may satisfy Equation 2 below:

8≤(D₂−D₁)/D₁×100≤15 [Equation 2]

D₁ indicates the density (g/cm³) of the mixture film before the lamination, and

D₂ indicates the density (g/cm³) of the mixture film after the lamination.

Specifically, during the lamination, the density increase rate of the mixture film may satisfy 8 to 15%, 9 to 15%, or 10 to 15%. D₁ and D₂ may be in the range of 2 to 4 g/cm³. Meanwhile, when the density increase rate of the mixture film is less than 8%, as described above, the adhesion between the mixture film and the current collector may decrease, and when the density increase rate of the mixture film is more than 15%, there may be a problem in that the porosity is lowered, and the positive electrode active material or the current collector is damaged.

In one example, when the mixture film is laminated on both surfaces of the current collector, the compression ratio (%) of Equation 1 may be represented by Equation 3 below.

30≤(T₁+0.5T_{c}−0.5T_{gap})/T₁×100≤50 [Equation 3]

In Equation 3, T₁ indicates the thickness of the mixture film before the lamination, T_{c} indicates the thickness of the current collector, and T_{gap} indicates a gap between first and second press rolls.

Meanwhile, a rolling rate of the mixture film that has been subjected to lamination may be 20% or less, specifically, 18% or less, 15% or less, 5% to 15%, 6% to 15%, 7% to 15%, or 9% to 13%. Here, the rolling rate represents a ratio of the thickness of the mixture film after lamination to the thickness of the mixture film before lamination ((T₁−T₂)/T₁×100). In the present technology, the rolling rate may satisfy the above range, so a suitable density of the mixture film and adhesion between the mixture film and the current collector may be realized.

In addition, the lamination may be performed under a temperature condition satisfying a specific range to optimize the density of the mixture film, and provide excellent adhesion between the mixture film and the current collector.

Specifically, the lamination may be performed using a press roll, and the temperature of the press roll may be adjusted to a range of 40 to 200° C. on average. Specifically, the temperature of the press roll may be controlled to the temperature condition of 40 to 200° C.; 80 to 150° C.; or 100 to 150° C. For the lamination, when the temperature of the press roll is less than 40° C., the mixture film may not be easily adhered to the current collector, and when the temperature of the press roll is more than 200° C., due to the high temperature, the current collector or the mixture film may be damaged. Therefore, for the lamination, the temperature of the press roll is preferably in the above range.

In the dry method of manufacturing a positive electrode for a lithium secondary battery according to the present technology, a mixture film including a positive electrode active material, a conductive material and a binder may be prepared, and the mixture film may be laminated to be integrated with a current collector such that the compression ratio of the mixture film satisfies Equation 1. Therefore, the manufactured positive electrode has an effect of realizing a positive electrode mixture layer with an appropriate density, and effective adhesion between the positive electrode mixture layer and the current collector.

Positive Electrode for Lithium Secondary Battery

In addition, in one embodiment of the present invention, a positive electrode for a lithium secondary battery includes

a current collector;

a primer layer formed on one or both surfaces of the current collector; and

a positive electrode mixture layer disposed on an upper surface of the primer layer, and including a positive electrode active material, conductive material and a binder,

wherein the positive electrode mixture layer has a structure in which the binder is fiberized and has a density of 2 to 4 g/cm³.

The positive electrode for a lithium secondary battery according to the present technology includes a positive electrode mixture layer formed by stacking and rolling a mixture film obtained by a dry process on the primer layer formed on one or both surfaces of the current collector, and the positive electrode mixture layer has a configuration in which a positive electrode active material, a conductive material, and a binder are contained.

Here, the binder included in the positive electrode mixture layer may have a fibrous structure. Specifically, when a mixture film is formed in the above-described dry method of manufacturing a positive electrode, in the process of mixing a mixture, the binder forms a network physically connecting the mixture.

In addition, as the positive electrode for a lithium secondary battery according to the present technology satisfies a compression ratio of Equation 1 during rolling, an appropriate density of the positive electrode mixture layer may be provided. Specifically, the density of the positive electrode mixture layer may be in the range of 2 to 4 g/cm³. Due to the density of the positive electrode mixture layer, it is possible to realize high capacity and high energy density.

The positive electrode active material may be any material that contains lithium to enable intercalation and deintercalation of lithium ions. For example, examples of the positive electrode active materials may include a layered compound such as lithium cobalt oxide (LiCoO₂) or lithium nickel oxide (LiNiO₂) or a compound substituted with one or more transition metals; a lithium manganese oxide represented by the formula Li₁₊ₓMn₂₋ₓO₄ (wherein x is 0 to 0.33), such as LiMnO₃, LiMn₂O₃, or LiMnO₂; lithium copper oxide (Li₂CuO₂); a vanadium oxide such as LiV₃O₈, LiFe₃O₄, V₂O₅, or Cu₂V₂O₇; an N site-type lithium nickel oxide represented by the formula LiNi₁₋ₓMₓO₂ (wherein M=Co, Mn, Al, Cu, Fe, Mg, B or Ga, x=0.01 to 0.3); a lithium manganese composite oxide represented by the formula LiMn₂₋ₓMₓO₂ (wherein M=Co, Ni, Fe, Cr, Zn or Ta, x=0.01 to 0.1) or Li₂Mn₃MO₈ (wherein M=Fe, Co, Ni, Cu or Zn); a lithium manganese composite oxide having a spinel structure, represented by LiNiₓMn₂₋ₓO₄; LiMn₂O₄ in which some Li ions in the formula are substituted with alkaline earth metal ions; a disulfide compound; and Fe₂(MoO₄)₃, but the present technology is not limited thereto. In addition, the positive electrode may include a positive electrode mixture layer including a lithium metal, a carbon material, a metal compound and a mixture thereof. The metal compound may be a compound containing one or more metal elements selected from the group consisting of Si, Ge, Sn, Pb, P, Sb, Bi, Al, Ga, In, Ti, Mn, Fe, Co, Ni, Cu, Zn, Ag, Mg, Sr, and Ba, and a mixture thereof.

In addition, the conductive material of the positive electrode mixture layer may include one or more selected from the group consisting of activated carbon, natural graphite, artificial graphite, carbon black, acetylene black, Denka Black, Ketjen black, Super-P, channel black, furnace black, lamp black, thermal black, graphene, and carbon nanotubes. For example, the conductive material may include one or more selected from the group consisting of carbon black, Ketjen black, and carbon nanotubes.

In addition, the binder may serve to adhere the positive electrode active material and the conductive material to each other, and may be any one that has such a function without particular limitation. Specifically, as the binder, polytetrafluoroethylene (PTFE) may be included. In a specific example, the binder may be polytetrafluoroethylene (PTFE), a polyolefin, or a mixture thereof, and particularly, polytetrafluoroethylene (PTFE). In another example, the polytetrafluoroethylene may be included at 60 wt % or more based on the total weight of the binder of the positive electrode mixture layer. Here, it goes without saying that the examples of the binders may further include polyethylene oxide (PEO), polyvinylidene fluoride (PVdF), and polyvinylidene fluoride-co-hexafluoropropylene (PVdF-HFP).

In addition, the positive electrode mixture layer may include 85 to 98 parts by weight of the positive electrode active material; 0.5 to 10 parts by weight of the conductive material; and 0.5 to 10 parts by weight of the binder based on a total of 100 parts by weight. In one example, the positive electrode mixture layer may include 88 to 97 parts by weight of the positive electrode active material, 0.5 to 5 parts by weight of the conductive material, and 1 to 5 parts by weight of the binder based on a total of 100 parts by weight. In another example, the positive electrode mixture layer may include 90 to 96 parts by weight of the positive electrode active material, 1 to 5 parts by weight of the conductive material and 2 to 5 parts by weight of the binder based on a total of 100 parts by weight.

Moreover, the average thickness of the positive electrode mixture layer may be, but is not particularly limited to, 10 to 300 μm, and specifically, 50 to 250 μm; 100 to 240 μm; 120 to 220 μm; 130 to 200 μm; or 150 to 180 μm.

Meanwhile, in the positive electrode for a lithium secondary battery according to the present technology, as a current collector, a material that has high conductivity without causing a chemical change in the battery may be used. For example, as the positive electrode current collector, stainless steel, aluminum, nickel, titanium, or calcined carbon may be used, and in the case of aluminum or stainless steel, one that is surface treated with carbon, nickel, titanium or silver may also be used. In addition, the current collector may have fine irregularities on a surface to increase the adhesion of the positive electrode active material, and may be formed in various shapes such as a film, a sheet, a foil, a net, a porous body, a foam body, and a non-woven fabric body. Moreover, the average thickness of the current collector may be appropriately applied within 3 to 500 μm by considering the conductivity and total thickness of the positive electrode to be manufactured.

In addition, the positive electrode for a lithium secondary battery according to the present technology includes a primer coating layer between the positive electrode mixture layer and the current collector to provide excellent adhesion between the positive electrode mixture layer and the current collector. The primer layer may be formed by preparing a slurry for forming a primer layer including a conductive material, a binder and a solvent, and applying and drying the slurry for forming a primer layer on one or both surfaces of the current collector. Here, the conductive material included in the primer layer may implement the surface roughness of the primer layer and provide conductivity. The conductive material is not limited as long as it does not cause a chemical change in the battery and has conductivity, and may be graphite such as natural graphite or artificial graphite; carbon black such as carbon black, acetylene black, Ketjen black, channel black, furnace black, lamp black or thermal black; a conductive fiber such as carbon fiber or metal fiber; a metal powder such as carbon fluoride, aluminum or nickel powder; a conductive whisker such as zinc oxide or potassium titanate; a conductive metal oxide such as titanium oxide; or a conductive material such as a polyphenylene derivative. For example, the conductive material of the primer layer may be carbon black.

The binder serves to adhere and fix the conductive material particles to each other to implement the surface roughness of the conductive material, and may include one or more selected from the group consisting of acrylonitrile-butadiene rubber, acrylonitrile-butadiene-styrene rubber, polyvinylidene fluoride, a polyvinylidene fluoride-based polymer, and an acryl-based resin. The acryl-based resin may be an acrylate-based polymer. For example, the acrylate-based polymer may include one or more selected from the group consisting of 2-ethylhexylacrylate, methyl methacrylate, ethyl methacrylate, n-propyl methacrylate, i-propyl methacrylate, n-butyl methacrylate, acrylamide, 1,4-benzenedicarboxylic acid, and acrylonitrile.

The conductive material and the polymer binder may be included in a weight ratio of 1:10 to 9:10. More specifically, the conductive material and the polymer binder may be included in a weight ratio of 3:10 to 9:10; 5:10 to 9:10; or 7:10 to 9:10. When the above weight ratio is satisfied, the conductivity of the primer coating layer may be achieved, and the delamination of the primer layer may be prevented.

The positive electrode for a lithium secondary battery according to the present technology includes, as described above, a positive electrode mixture layer formed by stacking a mixture film obtained by a dry process on the primer layer formed on one or both surfaces of the current collector and rolling the resultant. Particularly, since the positive electrode mixture layer has an appropriate density, it is possible to realize high capacity and high energy density.

Lithium Secondary Battery

Furthermore, in one embodiment of the present invention,

a lithium secondary battery including the above-described positive electrode according to the present technology, a negative electrode, and a separator interposed between the positive electrode and the negative electrode is provided.

Here, the negative electrode may be manufactured by applying, drying and pressing a negative electrode active material on a negative electrode current collector, or manufactured in a dry method like the above-described method of manufacturing a positive electrode, and may further selectively include a conductive material, an organic binder polymer or an additive, like the positive electrode, as necessary.

In addition, the negative electrode active material may include, for example, a carbon material and a silicon material. The carbon material refers to a carbon material including a carbon atom as a main component, and examples of the carbon material may include graphite having a completely layered crystalline structure such as natural graphite, soft carbon having a low crystalline layered crystalline structure (graphene structure; a structure in which hexagonal honeycomb planes of carbon are arranged in layers) and hard carbon in which the above-described structure is mixed with amorphous parts, artificial graphite, expanded graphite, carbon nanofibers, non-graphitizing carbon, carbon black acetylene black, Ketjen black, carbon nanotubes, fullerenes, activated carbon, and graphene, and preferably, one or more selected from the group consisting of natural graphite, artificial graphite and carbon nanotubes. More preferably, the carbon material includes natural graphite and/or artificial graphite, and may include any one or more of carbon black and carbon nanotubes in addition to the natural graphite and/or artificial graphite. In this case, the carbon material may include 0.1 to 10 parts by weight, and more specifically, 0.1 to 5 parts by weight or 0.1 to 2 parts by weight of carbon black and/or carbon nanotubes based on 100 parts by weight of the entire carbon material.

In addition, the silicon material may include one or more of a silicon (Si) particle and a silicon oxide (SiO_{X}, 1≤X≤2) particle as a particle including silicon (S), which is a metal component, as a main component. In one example, the silicon material may include a silicon (Si) particle, a silicon monoxide (SiO) particle, a silicon dioxide (SiO₂) particle, or a mixture thereof.

Moreover, the silicon material may have a form in which a crystalline particle and an amorphous particle are mixed, and the proportion of the amorphous particles may be 50 to 100 parts by weight, and specifically, 50 to 90 parts by weight; 60 to 80 parts by weight, or 85 to 100 parts by weight based on 100 parts by weight of the entire silicon material. In the present technology, thermal stability and flexibility may be improved without degrading the electrical properties of an electrode by controlling the proportion of the amorphous particles included in the silicon material to the above range.

In addition, the silicon material contains a carbon material and a silicon material, and may be included at 1 to 20 parts by weight, and particularly, 5 to 20 parts by weight; 3 to 10 parts by weight; 8 to 15 parts by weight; 13 to 18 parts by weight; or 2 to 7 parts by weight based on 100 parts by weight of the negative electrode mixture layer.

In the present technology, an amount of lithium consumption and an irreversible capacity loss during the initial charging/discharging of the battery may be reduced and charging capacity per unit mass may also be improved by adjusting the contents of the carbon material and the silicon material included in the negative electrode active material to the above range.

In one example, the negative electrode active material may include 95±2 parts by weight of graphite; and 5±2 parts by weight of a mixture in which silicon monoxide (SiO) particles and silicon dioxide (SiO₂) particles are uniformly mixed based on 100 parts by weight of the negative electrode mixture layer. In the present technology, an amount of lithium consumption and an irreversible capacity loss during the initial charging/discharging of the battery may be reduced and charging capacity per unit mass may also be improved by adjusting the contents of the carbon material and the silicon material included in the negative electrode active material to the above range.

In addition, the negative electrode mixture layer may have an average thickness of 50 to 200 μm, and specifically, 50 to 180 μm, 100 to 150 μm, 120 to 200 μm, 140 to 200 μm, or 140 to 160 μm.

Moreover, the negative electrode current collector is not particularly limited as long as it does not cause a chemical change in the battery and has high conductivity, and may use, for example, copper, stainless steel, nickel, titanium, or calcined carbon, in the case of copper or stainless steel, one whose surface is treated with carbon, nickel, titanium or silver may be used. In addition, the negative electrode current collector, like the positive electrode current collector, has fine irregularities on a surface to reinforce the adhesion of the positive electrode active material and may be formed in various shapes such as a film, a sheet, a foil, a net, a porous body, a foam body, and a non-woven fabric body. In addition, the average thickness of the negative electrode current collector may be suitably applied within 3 to 500 μm in consideration of the conductivity and total thickness of the negative electrode to be formed.

In addition, as the separator, an insulating thin film, which is interposed between a positive electrode and a negative electrode and has high ion permeability and mechanical strength, is used. The separator is not particularly limited as long as it is conventionally used in the art, and specifically, a sheet or non-woven fabric made of chemically-resistant and hydrophobic polypropylene, a glass fiber, or polyethylene may be used. In some cases, a composite separator in which a porous polymer base material such as a sheet or non-woven fabric is coated with inorganic/organic particles by an organic binder polymer may be used. When a solid electrolyte such as a polymer is used as an electrolyte, the solid electrolyte may also serve as a separator. Moreover, the separator may have a pore diameter of 0.01 to 10 μm and a thickness of 5 to 300 μm on average.

Meanwhile, the positive electrode and the negative electrode may be wound in a jelly roll shape and accommodated in a cylindrical, prismatic or pouch-type battery, or accommodated in a pouch-type battery in a folding or stack-and-folding form, but the present invention is not limited thereto.

In addition, a lithium salt-containing electrolyte according to the present technology may consist of an electrolyte and a lithium salt, and as the electrolyte, a non-aqueous organic solvent, an organic solid electrolyte, or an inorganic solid electrolyte may be used.

As the non-aqueous organic solvent, for example, aprotic organic solvents such as N-methyl-2-pyrrolidinone, ethylene carbonate, propylene carbonate, butylene carbonate, dimethyl carbonate, diethyl carbonate, γ-butyrolactone, 1,2-dimethyoxy ethane, tetrahydroxy franc, 2-methyl tetrahydrofuran, dimethyl sulfoxide, 1,3-dioxolane, formamide, dimethylformamide, dioxolane, acetonitrile, nitromethane, methyl formate, methyl acetate, phosphoric acid triester, trimethoxy methane, a dioxolane derivative, sulfolane, methyl sulfolane, 1,3-dimethyl-2-imidazolidinone, a propylene carbonate derivative, a tetrahydrofuran derivative, ether, methyl propionate, and ethyl propionate may be used.

As the organic solid electrolyte, for example, polymers such as a polyethylene derivative, a polyethylene oxide derivative, a polypropylene oxide derivative, a phosphoric acid ester polymer, poly agitation lysine, polyester sulfide, polyvinyl alcohol, polyvinylidene fluoride, and polymers including an ionic dissociation group may be used.

As the organic solid electrolyte, for example, an Li nitride, halide or sulfate such as Li₃N, LiI, Li₅Ni₂, Li₃N—LiI—LiOH, LiSiO₄, LiSiO₄—LiI—LiOH, Li₂SiS₃, Li₄SiO₄, Li₄SiO₄—LiI—LiOH, or Li₃PO₄—Li₂S—SiS₂ may be used.

The lithium salt is a material that is good for dissolving in the non-aqueous electrolyte, and may be, for example, LiCl, LiBr, LiI, LiClO₄, LiBF₄, LiB10Cl₁₀, LiPF₆, LiCF₃SO₃, LiCF₃CO₂, LiAsF₆, LiSbF₆, LiAlCl₄, CH₃SO₃Li, (CF₃SO₂)₂NLi, chloroborane lithium, lower aliphatic carboxylic acid lithium, lithium 4-phenylborate, or a lithium imide.

In addition, to improve charging/discharging characteristics and flame retardancy, for example, pyridine, triethylphosphite, triethanolamine, cyclic ether, ethylene diamine, n-glyme, hexaphosphoric acid triamine, a nitrobenzene derivative, sulfur, a quinone imine dye, N-substituted oxazolidinone, N, N-substituted imidazolidine, ethylene glycol dialkyl ether, an ammonium salt, pyrrole, 2-methoxy ethanol, or aluminum trichloride may be added to the electrolyte. In some cases, to impart non-flammability, a halogen-containing solvent such as carbon tetrachloride or ethylene trifluoride may be further included, and to enhance high-temperature storage properties, carbon dioxide gas may be further included, and fluoro-ethylene carbonate (FEC) or propene sultone (PRS) may be also included.

Meanwhile, one embodiment of the present invention provides a battery module including the above-described secondary battery as a unit battery, and a battery pack including the battery module.

The battery pack may be used as a power source for medium-to-large devices requiring high-temperature stability, a long cycle characteristic, and a high-rate characteristic, and specific examples of the medium-to-large devices may include power tools moving by a battery-powered motor; electric cars including an electric vehicle (EV), a hybrid electric vehicle (HEV), and a plug-in hybrid electric vehicle (PHEV); electric two-wheeled vehicles including an E-bike and an E-scooter; an electric golf cart; and a power storage system, and more specifically, an HEV, but the present invention is not limited thereto.

Hereinafter, the present invention will be described in further detail with reference to examples and an experimental example.

However, the following examples and experimental example merely illustrate the present invention, and the content of the present invention is not limited to the following examples and experimental example.

### Examples 1 to 7 and Comparative Examples 1 to 4. Manufacture of Positive Electrode for Lithium Secondary Battery

A mixture was prepared by putting a positive electrode active material, activated carbon and carbon black, and polytetrafluoroethylene as a binder into a blender at 10,000 rpm for 1 minute. In addition, the temperature of a kneader was stabilized at 150° C., the mixture was added to the kneader, and then the kneader was operated at 50 rpm for 5 minutes, thereby preparing a bulk mixture. Afterward, the bulk mixture was put into a blender and pulverized at 10,000 rpm for 40 seconds, thereby obtaining a powder mixture for an electrode. Afterward, the powder mixture for electrode was put into a lab calender (roll diameter: 88 mm, roll temperature: 100° C., 20 rpm), thereby manufacturing a mixture film.

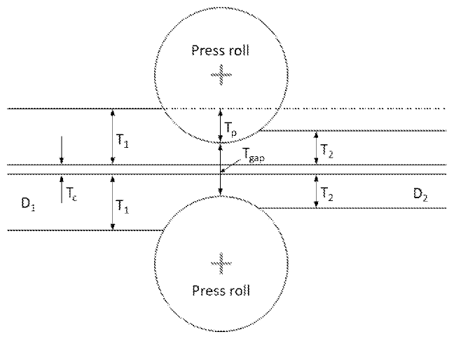

A primer layer was formed on the current collector by applying a slurry for forming a primer layer to an aluminum foil and drying the slurry. The primer layer includes carbon black and an acryl-based binder in a weight ratio of 5:6. In addition, a positive electrode was manufactured through a lamination process using a press roll which is maintained at 150° C. to laminate two sheets of the mixture film on both surfaces of the aluminum foil (average thickness: 19 μm) on which the primer layer is formed. Here, the composition of the mixture film and conditions for rolling are shown in Table 1 below. Among the active materials shown in Table 1 below, LMO is LiMnO₂, and LFP is LiFePO₄ (see FIG. 1).

TABLE 1

| | Composition of mixture film (parts | | | | | | | |
|---|---|---|---|---|---|---|---|---|
| | by weight) | | | | | | | |
| | | Conductive | | | | | | |
| | | material | | | | Thickness | | |
| | | (activated | | Mixture film | | of current | Gap | Compression |
| | Active | carbon:carbon | Binder | Thickness | Density | collector | thickness | ratio |
| | material | black) | (PTFE) | (T₁, μm) | (D₁, g/cm³) | (T_{c}, μm) | (T_{gap}, μm) | (%) |
| Example 1 | LMO 94 | 1:2 | 3 | 192.4 | 2.67 | 19 | 250 | 40.0 |
| Example 2 | LMO 94 | 1:2 | 3 | 187.7 | 2.57 | 19 | 220 | 46.5 |
| Example 3 | LMO 94 | 1:2 | 3 | 155.0 | 2.84 | 19 | 210 | 38.4 |
| Example 4 | LFP 94 | 0.5:2 | 3.5 | 144.6 | 2.27 | 19 | 180 | 44.2 |
| Example 5 | LFP 94 | 0.5:2 | 3.5 | 151.9 | 2.30 | 19 | 200 | 40.3 |
| Example 6 | LFP 94 | 0.5:2 | 3.5 | 148.1 | 2.31 | 19 | 210 | 35.4 |
| Example 7 | LFP 94 | 0.5:2 | 3.5 | 151.0 | 2.21 | 19 | 220 | 33.4 |
| Comparative | LMO 94 | 1:2 | 3 | 179.3 | 2.72 | 19 | 190 | 52.3 |
| Example 1 | | | | | | | | |
| Comparative | LMO 94 | 1:2 | 3 | 195.8 | 2.47 | 19 | 300 | 28.2 |
| Example 2 | | | | | | | | |
| Comparative | LFP 94 | 0.5:2 | 3.5 | 160.8 | 2.26 | 19 | 170 | 53.0 |
| Example 3 | | | | | | | | |
| Comparative | LFP 94 | 0.5:2 | 3.5 | 149.7 | 2.43 | 19 | 230 | 29.5 |
| Example 4 | | | | | | | | |

### Experimental Example

To evaluate the performance of the positive electrode for a secondary battery according to the present technology, the following experiments were carried out.

1) Measurement of Density Increase Rate

Before lamination of the mixture film on the current collector, a density (D₁) was calculated by measuring the thickness, area and mass of the mixture film. In addition, after the mixture film was laminated on the current collector, the thickness of the mixture film was calculated from the measured thickness of the positive electrode, and thus the density (D₂) of the mixture film after lamination was calculated.

In addition, a density increase rate was calculated by the equation (D₂−D₁)/D₁×100. Here, D₁ indicates the density of the mixture film before lamination, and D₂ indicates the density of the mixture film after lamination.

2) Measurement of Rolling Rate

The rolling rate of the mixture film was calculated by measuring the thicknesses (T₁, T₂) of the mixture film before and after lamination, respectively.

Specifically, the rolling rate was calculated by the equation (T₂−T₁)/T₁×100. Here, T₁ indicates the thickness of the mixture film before lamination, and T₂ indicates the thickness of the mixture film after lamination.

3) Measurement of Flexural Resistance

After each of the positive electrodes manufactured in Examples and Comparative Examples was wound on a sub-bar having a diameter of 8 mm, whether cracks occurred in the mixture film and whether there was adhesion between the mixture film and the current collector were visually observed.

TABLE 2

| | | | | | | Mixture film (after rolling) | | | | Visual |
|---|---|---|---|---|---|---|---|---|---|---|
| | Mixture film | | Thickness | Gap | | | | | Density | observation |
| | (before rolling) | | of current | thickness | Compression | | | Rolling | increase | during |
| | Thickness | Density | collector | of roll | ratio | Thickness | Density | rate | rate | electrode |
| | (T₁, μm) | (D₁, g/cm³) | (T_{c}, μm) | (T_{gap}, μm) | (%) | (T₁, μm) | (D₁, g/cm³) | (%) | (%) | bending |
| Example 1 | 192.4 | 2.67 | 19 | 250 | 40.0 | 171.1 | 3.00 | 11.1 | 12.5 | good |
| Example 2 | 187.7 | 2.57 | 19 | 220 | 46.5 | 164.2 | 2.94 | 12.5 | 14.3 | good |
| Example 3 | 155.0 | 2.78 | 19 | 210 | 38.4 | 144.5 | 3.05 | 6.8 | 9.7 | good |
| Example 4 | 144.6 | 2.27 | 19 | 180 | 44.2 | 129.5 | 2.53 | 10.4 | 11.7 | good |
| Example 5 | 151.9 | 2.30 | 19 | 200 | 40.3 | 137.3 | 2.54 | 9.6 | 10.6 | good |
| Example 6 | 148.1 | 2.31 | 19 | 210 | 35.4 | 136.9 | 2.50 | 7.6 | 8.2 | good |
| Example 7 | 151.0 | 2.21 | 19 | 220 | 33.4 | 139.3 | 2.51 | 7.7 | 8.4 | good |
| Comparative | 179.3 | 2.72 | 19 | 190 | 52.3 | 150.5 | 3.24 | 16.1 | 19.1 | Cracks |
| Example 1 | | | | | | | | | | occurred |
| Comparative | 195.8 | 2.47 | 19 | 300 | 28.2 | 180.5 | 2.68 | 7.8 | 8.4 | Interface |
| Example 2 | | | | | | | | | | delamination |
| Comparative | 160.8 | 2.26 | 19 | 170 | 53.0 | 137.0 | 2.65 | 14.8 | 17.4 | Cracks |
| Example 3 | | | | | | | | | | occurred |
| Comparative | 149.7 | 2.43 | 19 | 230 | 29.5 | 146.1 | 2.49 | 2.4 | 2.5 | Interface |
| Example 4 | | | | | | | | | | delamination |

Referring to Table 2, in the positive electrodes of Examples according to the present technology, a compression ratio of the mixture film was controlled to 30 to 50%. As a result, the density increase rate of the mixture film was shown in the range of 8 to 15%.

Particularly, when the compression ratio and the density increase rate of the mixture film satisfy Equations 1 and 2, respectively, during the measurement of flexural resistance of the electrode, no cracks in the mixture film or no delamination of the mixture film from the current collector was found. On the other hand, in the mixture films of Comparative Examples 1 and 3, cracks were observed. In addition, in the mixture films of Comparative Examples 2 and 3, the delamination of the mixture film from the current collector was observed. Although the mixture films of the positive electrodes prepared in Comparative Examples have similar densities to Examples, due to differences in the compression ratio and the density increase rate, cracks occurred in the mixture film, or the mixture films were delaminated from the current collector. Specifically, it was confirmed that, when the compression ratio and the density increase rate are high, cracks occurred in the mixture film, and when the compression ratio and the density increase rate are low, the mixture film is delaminated from the current collector.

From the above results, the dry method of manufacturing a positive electrode for a lithium secondary battery according to the present technology includes laminating a mixture film on a current collector, and by laminating the mixture film on the current collector such that the compression ratio of the mixture film satisfies Equation 1, a positive electrode having a positive electrode mixture layer with an appropriate density may be manufactured, and the method has an effect of realizing effective adhesion between the positive electrode mixture layer and the current collector.

As above, the present invention has been described with reference to exemplary embodiments, but it should be understood by those skilled in the art or those of ordinary skill in the art that the present invention can be variously modified and changed without departing the spirit and technical scope of the present invention described in the accompanying claims.

Accordingly, the technical scope of the present invention is not limited to the content described in the detailed description of the specification, but should be defined by the claims.

1. A dry method of manufacturing a positive electrode for a lithium secondary battery, comprising:
laminating a mixture film comprising a positive electrode active material, a conductive material and a binder on one or both surfaces of a current collector,
wherein, during the lamination, the mixture film satisfies a compression ratio (%) of Equation 1:
30≤Tₚ/T₁×100≤50 [Equation 1]
In Equation 1,
Tₚ indicates a pressing thickness of the mixture film in the lamination, and
T₁ indicates a thickness of the mixture film before the lamination.

2. The method of claim 1, wherein, in the lamination, a density increase rate (%) of the mixture film satisfies Equation 2 below:
8≤(D₂−D₁)/D₁×100≤15 [Equation 2]
D₁ indicates a density of the mixture film before the lamination, and
D₂ indicates a density of the mixture film after the lamination.

3. The method of claim 1, wherein, in the lamination, a rolling rate of the mixture film is 20% or less,
wherein the rolling rate is a ratio of a thickness of the mixture film after the lamination to the thickness of the mixture film before the lamination ((T₂−T₁)/T₁×100), and
T₂ indicates a thickness of the mixture film after the lamination.

4. The method of claim 1, further comprising:
before the lamination, forming a primer layer comprising the conductive material and the binder on the one or both surfaces of the current collector.

5. The method of claim 1, further comprising:
obtaining a powder mixture by dry mixing the positive electrode active material, the conductive material and the binder; and
a forming the mixture film by calendering the powder mixture.

6. The method of claim 5, wherein the obtaining of the powder mixture comprises
obtaining a mixture by mixing the positive electrode active material, the conductive material and the binder;
forming a bulk mixture in the form of a lump by fiberizing the binder by applying shear stress to the mixture; and
obtaining the powder mixture by pulverizing the bulk mixture.

7. The method of claim 1, wherein the lamination is performed by a press roll.

8. The method of claim 7, wherein a temperature of the press roll ranges from 40 to 200° C. on average.

9. A positive electrode for a lithium secondary battery, comprising:
a current collector;
a primer layer formed on one or both surfaces of the current collector; and
a positive electrode mixture layer disposed on an upper surface of the primer layer and comprising a positive electrode active material, a conductive material and a binder,
wherein the positive electrode mixture layer has a structure formed by fiberization of the binder and has a density of 2 to 4 g/cm³.

10. The positive electrode of claim 9, wherein the positive electrode mixture layer comprises
85 to 98 parts by weight of the positive electrode active material;
0.5 to 5 parts by weight of the conductive material; and
0.5 to 10 parts by weight of the binder.

11. The positive electrode of claim 9, wherein the binder of the positive electrode mixture layer comprises polytetrafluoroethylene (PTFE).

12. The positive electrode of claim 9, wherein the primer layer comprises the conductive material and the binder, and
the conductive material and the binder are comprised in a weight ratio of 1:10 to 9:10.

13. The positive electrode of claim 12, wherein the binder included in the primer layer is one or more selected from the group consisting of acrylonitrile-butadiene rubber, acrylonitrile-butadiene-styrene rubber, polyvinylidene fluoride, a polyvinylidene fluoride-based copolymer, and an acryl-based resin.

14. A lithium secondary battery comprising the positive electrode of claim 9; a negative electrode; and a separator disposed between the positive electrode and the negative electrode.
